(19) United States
(12) Patent Application Publication
(10) Pub. No.: US 2012/0251674 A1
(43) Pub. Date: Oct. 4, 2012

(54) WRAPPED FRIED FOOD

(75) Inventors: Tomohiko INO, Ibaraki (JP); Manami FUJITA, Ibaraki (JP)

(73) Assignee: MARUHA NICHIRO FOODS, INC., Tokyo (JP)

(21) Appl. No.: 13/435,691

(22) Filed: Mar. 30, 2012

(30) Foreign Application Priority Data
Apr. 1, 2011 (JP) 2011-082028

(51) Int. Cl. A21D 13/00; A23L 1/01; A21D 2/00

(52) U.S. Cl. 426/94; 426/297; 426/439

(57) ABSTRACT

It is intended to provide: a wrapped food to be fried that allows a wrapped fried food to effectively maintain its oil cooking-derived crunchy texture based on the layered structure of wrappers wrapped around an ingredient; a wrapped fried food obtained by cooking the same with oil; and methods for producing these foods. The wrapped fried food of the present invention has an ingredient and a wrapper portion wrapped around the ingredient. At least a portion of this wrapper portion is formed as a layered structure consisting of 10 or more wrapper layers in a rolled-up state.

### BACKGROUND OF THE INVENTION

1. Field of the Invention

The present invention relates to: a wrapped food to be fried, such as harumaki (spring roll or egg roll), containing an ingredient wrapped in a wrapper; a wrapped fried food obtained by cooking the same with oil; and methods for producing these foods.

2. Description of the Related Art

Wrapped fried foods prepared by wrapping an ingredient in a wrapper and cooking it with oil include many foods such as harumaki, similar products thereof, and various wrapped fries. For the wrapped fried foods, such as harumaki, importance is placed on a wrapper having a crunchy texture which is a determinant factor of good or poor quality.

However, a harumaki wrapper absorbs water from the ingredient or the like and loses its crunchy texture if it takes time before harumaki cooked with oil is eaten or if harumaki cooked with oil and then cryopreserved is microwaved.

Thus, known methods for sustaining the crunchy texture of a harumaki wrapper involve optimizing the formulation of the wrapper (JP3682505B, JP3682514B, and JP3995573B). Alternative known methods involve: optimizing a method of baking or shaping a wrapper (JP3186523B); coating the surface of contact between a baked wrapper and an ingredient with a food material containing a hydrophobic substance to prevent the movement of water from the fillings (JP3179955B, JP3672668B, and JP2007-209206A); or sustaining the crunchy texture of a wrapper by a devised manner to roll up the wrapper (JP07-213261A and JP4157354B).

The inventions disclosed in these Patent Literatures improve the combination of the components of a harumaki wrapper or a method of baking or shaping a wrapper, or produce a crunchy texture based on a manner to wrap an ingredient in one wrapper. Thus, none of the wrapped fried foods according to the Patent Literatures listed above have an increase in the number of layers in the layered structure of a wrapper portion, compared with a manner to roll up a wrapper by a method known in the art. No previous report discloses a method for improving a texture by increasing the number of layers in the layered structure. Also, all of these Patent Literatures discuss how the crunchy texture of one wrapper in a rolled-up state can be sustained. No study has been made on stacking several wrappers and then wrapping an ingredient in the stack.

Thus, an object of the present invention is to provide a wrapped fried food that can effectively maintain its oil cooking-derived crunchy texture based on the layered structure of wrappers wrapped around an ingredient, and a method for producing the same. Another object of the present invention is to provide a wrapped food to be fried for production of the wrapped fried food by cooking with oil, and a method for producing the same.

### SUMMARY OF THE INVENTION

The present inventors have conducted intensive studies to attain the objects. Consequently, it was difficult to maintain an oil cooking-derived crunchy texture over a long time according to the wrapped fried foods prepared by some methods previously proposed. Such tendency was especially remarked when harumaki cooked with oil was frozen and microwaved. As a result of studying a cause thereof, that wrapper layers absorbed water from the fillings after cooking with oil or microwaving, and thereby stick together, i.e., 8 layers of a rolled-up wrapper, for example, are substantially reduced to half or less (4 layers or so), resulting in lick of easy brake of the layer for crispy feeling. It has been found that the crunchy and crispy texture of harumaki is based on the layered structure of the harumaki wrapper and harumaki having a multi-layered structure, in which 10 or more layers are present at least at one area of this layered structure maintains its texture even after a long time has passed from cooking with oil or microwaving. The present invention has been completed on the basis of these findings.

A wrapped food to be fried of the present invention comprises an ingredient and a wrapper portion wrapped around the ingredient, wherein at least one part of the wrapper portion has a layered structure comprising 10 or more wrapper layers in a rolled-up state.

A wrapped fried food of the present invention is obtained by cooking, with oil, the wrapped food to be fried.

A method for producing a wrapped food to be fried of the present invention is a method for producing a wrapped food to be fried comprises an ingredient wrapped in a wrapper portion, comprising:

wrapping the ingredient in the wrapper to form a layered structure comprising 10 or more wrapper layers in a rolled-up state at least in a part of the wrapper part around the ingredient.

A method for producing a wrapped fried food of the present invention includes cooking, with oil, the above wrapped food to be fried.

The wrapped fried food of the present invention has a wrapper portion comprising 10 or more layers in its layered structure, which can prevent time-dependent reduction in the texture of the wrapper after cooking with oil. Thus, the wrapped fried food of the present invention can maintain its crunchy and crispy texture obtained immediately after cooking with oil. Also, the product of the present invention cooked with oil and then stored at room temperature, refrigerated, or cryopreserved can offer a crunchy and crispy texture to an eater even after being reheated in a microwave oven.

### BRIEF DESCRIPTION OF THE DRAWING

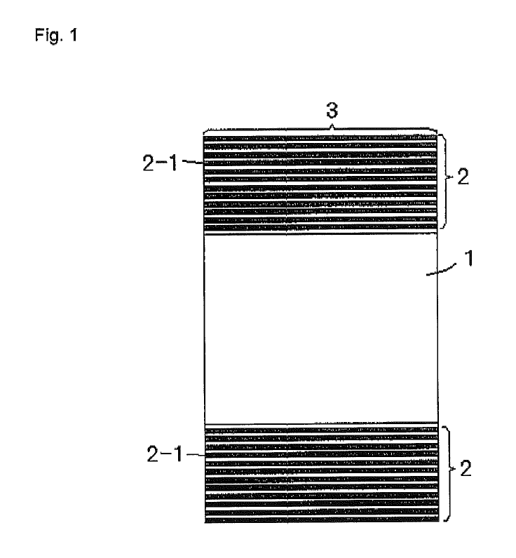

FIG. 1 is a drawing schematically showing the cross-sectional structure in the thickness direction of harumaki according to the present invention. In FIG. 1, each parts are indicated by the following numbers:
1: Ingredient-containing hollow portion
2: Wrapper portion
2-1: Wrapper (layer)
3: Multi-layered structure-forming portion

### DETAILED DESCRIPTION OF THE PREFERRED EMBODIMENTS

Hereinafter, the present invention will be described in detail.

The wrapped fried food according to the present invention is obtained by cooking, with oil, a wrapped food to be fried obtained by wrapping an ingredient in a wrapper. The wrapped fried food encompasses harumaki, similar products thereof, and various wrapped fries of various fishery products such as shrimps, solid dairy products such as cheese, various vegetables, or various meats, or a mixture of two or more thereof (e.g., wrapped fried shrimps, wrapped fried cheese, wrapped fried green soybeans, and fried shumai; shao-mai or steamed Chinese meat dumpling wrapped in a dough skin). In the wrapped fried food according to the present invention, the ingredient does not have to be wholly covered with the wrapper and may be partially exposed as long as the form of the wrapped fried food is maintained.

In the wrapped fried food of the present invention, at least one part of the wrapper portion wrapped around the ingredient is provided with 10 or more wrapper layers as a layered structure in a rolled-up state.

FIG. 1 shows a schematic cross-sectional view in the thickness direction of harumaki as one example of the wrapped fried food according to the present invention. The harumaki shown in FIG. 1 has multi-layered structure-forming portion 3 in which hollow portion 1 containing harumaki ingredients (fillings) is formed by wrapper portion 2 that is wrapped around the ingredients so that wrapper portion 2 has a layered structure consisting of wrapper layers 2-1 by overlaying wrappers each other in a rolled-up state. The example shown in FIG. 12 wrapper layers 2-1 were layered both of the upper and lower side in a rolled-up state.

According to the present invention, the wrapper portion of the wrapped fried food at least partially has a layered structure consisting of 10 or more wrapper layers in a rolled-up state, as described above, and can thereby maintain its oil cooking-derived crunchy texture. The wrapped fried food, even when cryopreserved and then heated, can obtain this crunchy texture. Particularly, in the present invention, the 10 or more wrapper layers in the layered structure formed in at least one portion of the wrapper enable the stacked state of each layer to be maintained by cooking with oil and also enable the oil cooking-derived crunchy texture to be maintained because air incorporated between the layers inhibits the adhesion or sticking between the layers.

Such a multi-layered structure can be achieved by shaping one piece of wrapper dough by baking or rolling into each sheet having a thickness from 0.1 mm to 0.6 mm, stacking the sheets such that the stacked portion is within 1.0 mm in thickness, and then rolling up the stack.

Alternatively, the multi-layered structure can also be obtained by a method comprising shaping wrapper dough by baking or rolling into a sheet(s) having a thickness from 0.1 mm to 0.6 mm, placing the ingredient on the baked or rolled wrapper, then covering the ingredient with an additional wrapper(s) such that the stacked portion is within 1.0 mm in thickness, and rolling up the wrapper stack. In this case, the additional wrapper to cover it later may be one wrapper sheet or a stack of several wrappers.

The stack in these methods may be formed by folding one wrapper sheet, formed by stacking several wrapper sheets, or formed by combining these two approaches.

The innermost layer of the wrapper portion contacted with the ingredient tends to absorb water from the fillings and easily stick to the adjacent wrapper layers. These wrapper layers that have stuck together to become thick are too chewy to bite off and are consequently perceived to lack a crunchy texture and have a poorly bitten-off texture. Thus, as described above, the ingredient is placed on the stacked wrapper portion before rolling up, wherein the stacked portion has a total thickness as small as 1 mm or smaller. This structure can more effectively reduce the influence of water absorbed from the ingredient on the outer layers and prevent reduction in crunchy texture.

The ingredient used in the wrapped fried food of the present invention can be selected for use according to the form of the wrapped fried food, such as harumaki. The combination of the ingredient is not particularly limited, and even an ingredient combined and formulated as known in the art can exert effects by virtue of the multi-layered structure. The ingredient known in the art often has formulation having a water content as small as possible, for example, with a water content reduced by stir-frying vegetables, etc. On the other hand, the multi-layered structure according to the present invention allows preparation of crunchy harumaki that is resistant to time-dependent change after cooking with oil even using an ingredient to which water is added in an amount up to 50% of the ingredient formulation.

Each wrapper can also be selected for use according to the kind of the wrapped fried food, such as harumaki and fried shumai. Typically, a noodle sheet composed mainly of flour such as dough can be used as a wrapper.

The composition of the wrapper dough is not particularly limited, and materials selected, according to the kind of the wrapped fried food, from flour, starch, processed starch, rice flour, oils and fats, proteins, sugars, reducing sugars, sugar alcohols, salts, thickeners, gelling agents, emulsifiers, amino acids, dyes, brine, various extracts, seasonings, etc., can be mixed, as already known in the art.

The wrapper obtained by baking can be produced continuously by applying a batter to the surface of, for example, a drum for heating to form a thin layer of batter and backing it. The thickness of the wrapper can be changed, as desired, depending on the amount of a batter portion supplied to the surface of a drum, the thickness of the applied batter portion, and the rotational speed of the drum.

The wrapper obtained by extending under pressure such as rolling can be produced continuously by thinly extending wrapper dough stepwise or continuously, for example, by a roller(s). The thickness of the wrapper can be changed, as desired, depending on the distance between the rollers. In this case, a wrapper having a thickness smaller than 0.1 mm has the possibility that the wrapper may be broken during wrapper preparation or cracked during wrapping of the ingredient or during cooking with oil, disadvantageously resulting in poor machinability and a lack of a crunchy and crispy texture in eating. Alternatively, a wrapper having a thickness exceeding 0.6 mm or a wrapper stack having a thickness exceeding 1.0 mm before rolling up have the possibility that the wrapper may offer a poorly bitten-off texture in eating, disadvantageously resulting in a lack of a crispy texture.

Thus, it is preferable that each wrapper layer to from the multi-layered structure have a thickness selected from the range of 0.1 mm to 0.6 mm, preferably 0.2 mm to 0.5 mm, during the preparation of the wrapped food to be fried. Also, the wrapper stack composed of tow or more wrappers before wrapping of the ingredient has a thickness of preferably 1.0 mm or smaller, more preferably ranging from 0.4 to 0.7 mm.

When the number of the layers in the multi-layered structure is more than 10, the number the layer is preferably 24 or less than 24. The percentage of the multi-layered structure-forming portion to the outer peripheral surface of the wrapped fried product is set to preferably 25% or more, more preferably 50% or more. The entire surface of the wrapped fried product may be wrapped by the multi-layered structure.

For stacking wrappers in advance, it is desirable that these wrappers have the same size and thickness in planar shape. The size of each wrapper in planar shape is not particularly limited as long as the size allows the wrapper portion to have 10 or more layers at least at one area in its layered structure in a rolled-up state. Even when two or more wrappers different in thickness are used, the effects of the present invention can be obtained.

The wrappers thus obtained may be stacked by any of a method involving stacking wrappers of the same size having the desired same size; and a method involving preparing in advance wrappers larger than the desired size and adjusting it to the desired size by folding.

Alternatively, these wrappers are stacked, while a composition obtained using one or more materials selected from oil and fat, starch, sugars or reducing sugars, polysaccharide thickeners, emulsifiers, etc., can be applied between the wrappers to thereby inhibit the sticking between the wrappers. Before placement of the ingredient, this composition can also be applied to the surface of the wrapper to thereby prevent the movement of water from the fillings to the wrappers. Thus, the present invention can become more effectively. For example, it is preferable to use a method involving spraying 1 g to 3 g of oil or fat having such a sticking-preventing function over 50 to 100% of the whole wrapper surface having a typical size for wrapped fries.

The wrapped food to be fried, as a material for production of the wrapped fried food of the present invention, can be obtained by placing a desired ingredient on a wrapper(s) and rolling up the wrapper(s) into a desired shape by a method known in the art. As described above, an ingredient is wrapped in a wrapper(s) by, for example, a method including placing the desired ingredient on a wrapper stack and rolling up the stack by a method known in the art; or a method including placing the desired ingredient on a wrapper(s), further covering the exposed surface of the ingredient with an additional wrapper(s), and rolling up the stack by a method known in the art. The obtained wrapped food to be fried can have a shape according to the desired wrapped fried food.

The wrapped food to be fried thus obtained can be cryopreserved or refrigerated, if necessary. This wrapped food to be fried can be cooked with oil to obtain a wrapped fried food. The obtained wrapped fried food has a preferable texture in which its crunchy texture is maintained. Also, the obtained wrapped fried food can be refrigerated or cryopreserved and has a preferable texture in which its crunchy texture is maintained even when cooked by heating after the storage.

Specifically, the wrapped fried food of the present invention may be stored at room temperature, refrigerated, or cryopreserved after being cooked with oil and can be reheated by microwaving using a usual microwave oven or the like in eating.

### EXAMPLES

Hereinafter, the present invention will be described in more detail with reference to Examples and Comparative Examples and is, however, not intended to be limited to them. In all of these Examples and Comparative Examples, studies were conducted with formulation shown below.

### (1) Preparation of Baked Wrapper

100 parts by weight of flour (semi-hard flour), 2 parts by weight of common salt, and 110 parts by weight of water were sufficiently kneaded in a batter mixer, to prepare a batter. The obtained batter was stored at 5° C. for 12 hours or longer and then baked and cut by a method known in the art using a harumaki wrapper shaping machine (model: HTR-15; manufactured by Daiei Engineering Co., Ltd.) to obtain the wrapper dough of interest.

### (2) Preparation of Rolled Wrapper

100 parts by weight of flour (semi-hard flour), 1 part by weight of common salt, and 35 parts by weight of water were sufficiently mixed using a noodle sheeting mixer (model: MVH-02; manufactured by Tokyo Menki Co., Ltd.), to prepare noodle dough. The obtained noodle dough was stored at 5° C. for 1 hour and then rolled and cut by a method known in the art using a noodle rolling machine (model: Richman LM-5062; manufactured by Yamato Mfg Co., Ltd.) to obtain the wrapper dough of interest.

### (3) Preparation of Filling

15 parts by weight of ground pork, 10 parts by weight of chopped cabbage, 5 parts by weight of chopped bamboo shoot, 3 parts by weight of chopped carrot, and 3 parts by weight of chopped shiitake mushroom were well stir-fried with 20 parts by weight of cooking oil, and then seasoned with 1 part by weight of sugar, 0.8 parts by weight of Chinese soup, 0.5 parts by weight of common salt, 0.2 parts by weight of umami seasoning, 2 parts by weight of soy sauce, and 0.5 parts by weight of oyster sauce. These seasoned ingredients were supplemented with 50 parts by weight of water, then thickened by addition of 2.5 parts by weight of bean-starch vermicelli and 3.5 parts by weight of potato starch, boiled and then flavored with 1 part by weight of sesame oil to prepare fillings. The prepared fillings were stored at 5° C. for 12 hours or longer. Then, 30 g thereof was shaped into a size of approximately 110 mm×25 mm×10 mm and used as fillings.

### Example 1

Harumaki wrapper 1 of 200 mm×200 mm having a thickness of 0.18 mm was obtained by baking and cutting according to the above method (1). Three wrappers 1 were stacked with the corresponding sides of these wrappers neatly aligned, while 1 g of palm oil (melting point: 40° C.) was applied between the wrappers to obtain wrapper 2 (wrapper stack) of 200 mm×200 mm having a thickness of 0.57 mm. 1 g of palm oil (melting point: 40° C.) was applied to the surface of wrapper 2, on which the ingredient prepared in the above section (3) was then placed. The wrapper was rolled up by a method known in the art to obtain harumaki to be cooked with oil containing a wrapper portion having 21 layers at the maximum and 12 layers at the minimum in its layered structure.

### Example 2

Harumaki wrapper 1 of 200 mm×400 mm having a thickness of 0.25 mm was obtained in the same way as in Example 1. The obtained wrapper was folded into half lengthwise, while 1 g of palm oil (melting point: 40° C.) was applied between the wrappers to obtain wrapper 2 (wrapper stack) of 200 mm×200 mm having a thickness of 0.55 mm. 1 g of palm oil (melting point: 40° C.) was applied to the surface of wrapper 2, on which the ingredient prepared in the above section (3) was then placed. The wrapper was rolled up by a method known in the art to obtain harumaki to be cooked with oil containing a wrapper portion having 14 layers at the maximum and 8 layers at the minimum in its layered structure.

### Example 3

Harumaki wrapper 1 of 200 mm×200 mm having a thickness of 0.45 mm and harumaki wrapper 1′ of 160 mm×160 mm having a thickness of 0.25 mm were obtained in the same way as in Example 1.1 g of palm oil (melting point: 40° C.) was applied to the surface of wrapper 1, on which wrapper 1′ was stacked such that their centers were neatly aligned and the sides of each wrapper were parallel to the corresponding sides of the other wrapper to obtain wrapper 3 (wrapper stack) of 200 mm×200 mm having thicknesses of 0.75 mm in the central portion and 0.45 mm in the edge portion. 1 g of palm oil (melting point: 40° C.) was applied to the surface of wrapper 3, on which the ingredient prepared in the above section (3) was then placed. The wrapper was rolled up by a method known in the art to obtain harumaki to be cooked with oil containing a wrapper portion having 12 layers at the maximum and 7 layers at the minimum in its layered structure.

### Example 4

Harumaki wrapper 1 of 200 mm×400 mm having a thickness of 0.55 mm was obtained in the same way as in Example 1. The obtained wrapper was folded into half lengthwise, while 1 g of palm oil (melting point: 40° C.) was applied between the wrappers to obtain wrapper 2 (wrapper stack) of 200 mm×200 mm having a thickness of 1.15 mm. 1 g of palm oil (melting point: 40° C.) was applied to the surface of wrapper 2, on which the ingredient prepared in the above section (3) was then placed. The wrapper was rolled up by a method known in the art to obtain harumaki to be cooked with oil containing a wrapper portion having 14 layers at the maximum and 8 layers at the minimum in its layered structure.

### Example 5

Harumaki wrapper 1 of 200 mm×200 mm having a thickness of 0.65 mm and wrapper 1′ having a thickness of 0.25 mm were obtained in the same way as in Example 1. 1 g of palm oil (melting point: 40° C.) was applied to the surface of wrapper 1, on which wrapper was stacked with the corresponding sides of these wrappers neatly aligned to obtain wrapper 3 (wrapper stack) of 200 mm×200 mm having a thickness of 0.95 mm. 1 g of palm oil (melting point: 40° C.) was applied to the surface of wrapper 3, on which the ingredient prepared in the above section (3) was then placed. The wrapper was rolled up by a method known in the art to obtain harumaki to be cooked with oil containing a wrapper portion having 14 layers at the maximum and 8 layers at the minimum in its layered structure.

### Comparative Example 1

A harumaki wrapper of 200 mm×200 mm having a thickness of 0.55 mm was obtained in the same way as in Example 1.1 g of palm oil (melting point: 40° C.) was applied to the surface of the obtained wrapper, on which the ingredient prepared in the above section (3) was then placed. The wrapper was rolled up by a method known in the art to obtain harumaki to be cooked with oil containing a wrapper portion having 7 layers at the maximum and 4 layers at the minimum in its layered structure.

### (Evaluation 1)

The samples of Examples 1 to 5 and Comparative Example 1 were separately cryopreserved at −20° C. for 2 months, then cooked with cooking oil of 170 to 180° C. for 5 minutes, and left at room temperature. Their textures were confirmed in sensory evaluation by 10 panelists 10 minutes, 3 hours, and 6 hours after the cooking with oil.

In this sensory evaluation, the crunchy texture of each wrapper and the ease of biting off each wrapper were evaluated according to the following evaluation criteria, and the average of scores given by the 10 panelists was used as a score of quality.

### <Scoring Criteria>

### (1) Crunchy Texture of Each Wrapper

1: Crunchy texture was absent.
2: Crunchy texture was slightly lost.
3: Crunchy texture was present.
4: Considerably crunchy, favorable texture was present.
5: Crunchy texture equivalent to that obtained immediately after cooking with oil was present and exceedingly favorable.

### (2) Ease of Biting Off Each Wrapper

1: Wrapper was considerably chewy and poorly bitten off.
2: Wrapper was slightly chewy and poorly bitten off.
3: Wrapper was somewhat chewy, but easily bitten off.
4: Wrapper was almost not chewy and was easily bitten off,
5: Wrapper was not chewy at all and was exceedingly favorably bitten off.

As a result, the samples of Comparative Example 1 prepared by the production method known in the art had a crunchy texture 10 minutes after the cooking with oil, and this crunchy texture, however, was reduced with the passage of time after the cooking with oil, resulting in a poorly bitten-off, gummy texture. By contrast, the samples of Examples 1 to 3 maintained the texture obtained immediately after the cooking with oil, even after 6 hours passed from the cooking with oil. The samples in which each wrapper layer was thinner maintained a more easily bitten-off texture even after a time passed from the cooking with oil.

The samples of Example 4 having a wrapper stack exceeding 1.0 mm in thickness before rolling up and the samples of Example 5 having a wrapper sheet exceeding 0.6 mm in thickness (though their layered structures had 10 or more layers) maintained the crunchy textures of their outer layers even 6 hours after the cooking with oil. The inner layers of some samples absorbed water from the fillings and produced a poorly bitten-off texture.

### (Evaluation 2)

The samples (harumaki to be cooked with oil) of Examples 1 to 5 and Comparative Example 1 were separately cooked with cooking oil of 170 to 180° C. for 5 minutes and then quickly frozen at −40° C. for 40 minutes, and cryopreserved at −20° C. for 1 day or for 2 months. These two harumaki samples of each Example or Comparative Example were microwaved at 500 W for 2 minutes without being covered with a plastic wrap, then left at room temperature, and evaluated for their textures 10 minutes, 3 hours, and 6 hours after the cooking in the same way as in Evaluation 1.

As a result, the samples cryopreserved for 1 day produced the same results as in Evaluation 1. The samples of Examples 1 to 3 cryopreserved for 2 months maintained a crunchy, easily bitten-off texture even 6 hours after the microwaving, because the multi-layered structure of thin wrappers prevented the movement of water from the fillings during the cryopreservation.

The samples of Comparative Example 1 prepared by the production method known in the art already lost a crispy texture and the ease of biting them off, 10 minutes after the microwaving, and their qualities were deteriorated with the passage of time.

The samples of Examples 4 and 5 having 10 or more layers in their layered structures maintained a crunchy texture, compared with Comparative Example 1, because the movement of water from the fillings during the cryopreservation was prevented, as in Examples 1 to 3. Some samples of Examples 4 and 5, however, offered a poorly bitten-off texture due to the perceived thickness of their wrappers as a whole.

### Example 6

Noodle sheet wrapper 1 of 200 mm×200 mm having a thickness of 0.25 mm was obtained by rolling and cutting according to the above method (2). Two noodle sheet wrappers 1 were stacked, while 1 g of palm oil (melting point: 40° C.) was applied between the wrappers to obtain noodle sheet wrapper 2 (wrapper stack) of 200 mm×200 mm having a thickness of 0.55 mm. 1 g of palm oil (melting point: 40° C.) was applied to the surface of noodle sheet wrapper 2, on which the ingredient prepared in the above section (3) was then placed. The wrapper was rolled up by a method known in the art to obtain harumaki to be cooked with oil containing a wrapper portion having 14 layers at the maximum and 8 layers at the minimum in its layered structure.

### Example 7

Noodle sheet wrapper 1 of 200 mm×200 mm having a thickness of 0.55 mm was obtained in the same way as in Example 6. Two noodle sheet wrappers 1 were stacked, while 1 g of palm oil (melting point: 40° C.) was applied between the wrappers to obtain noodle sheet wrapper 2 (wrapper stack) of 200 mm×200 mm having a thickness of 1.15 mm. One g of palm oil (melting point: 40° C.) was applied to the surface of noodle sheet wrapper 2, on which the ingredient prepared in the above section (3) was then placed. The wrapper was rolled up by a method known in the art to obtain harumaki to be cooked with oil containing a wrapper portion having 14 layers at the maximum and 8 layers at the minimum in its layered structure.

### Comparative Example 2

A noodle sheet wrapper of 200 mm×200 mm having a thickness of 0.55 mm was obtained in the same way as in Example 6.1 g of palm oil (melting point: 40° C.) was applied to the surface of the obtained noodle sheet wrapper, on which the ingredient prepared in the above section (3) was then placed. The wrapper was rolled up by a method known in the art to obtain harumaki to be cooked with oil containing a wrapper portion having 7 layers at the maximum and 4 layers at the minimum in its layered structure.

### (Evaluation 3)

The samples of Examples 6 and 7 and Comparative Example 2 were separately cryopreserved at −20° C. for 2 months, then cooked with cooking oil of 170 to 180° C. for 10 minutes, and left at room temperature. Their textures were confirmed in sensory evaluation by 10 panelists 10 minutes, 3 hours, and 6 hours after the cooking with oil.

As a result, the samples of Comparative Example 2 and Example 7 had a crunchy texture 10 minutes after the cooking with oil, and this crunchy texture, however, was reduced with the passage of time after the cooking with oil, resulting in a poorly bitten-off, gummy texture. Example 7 was superior in crunchy texture to Comparative Example 2. By contrast, the samples of Example 6 maintained the texture obtained immediately after the cooking with oil, even after 6 hours passed from the cooking with oil.

Regarding the ease of biting off each wrapper, the samples of Example 6 and Comparative Example 2 were easily bitten off 10 minutes after the cooking with oil. Some samples of Example 7 became more difficult to bite off with the passage of time after the cooking, whereas the samples of Example 6 were not chewy and had an easily bitten-off texture even 6 hours after the cooking with oil. The samples of Example 7 having a wrapper stack exceeding 1.0 mm in thickness were poorly bitten off even 10 minutes after the cooking with oil. 6 hours after the cooking with oil, some samples of Example 7 were considerably chewy and offered a texture in which the innermost layer could not be bitten off.

### (Evaluation 4)

The samples (harumaki to be cooked with oil) of Examples 6 and 7 and Comparative Example 2 were separately cooked with cooking oil of 170 to 180° C. for 10 minutes and then quickly frozen at −40° C. for 40 minutes, and cryopreserved at −20° C. for 1 day or for 2 months. These two harumaki samples of each Example or Comparative Example were microwaved at 500 W for 2 minutes without being covered with a plastic wrap, then left at room temperature, and evaluated for their textures 10 minutes, 3 hours, and 6 hours after the cooking in the same way as in Evaluation 1.

As a result, the samples of Comparative Example 2 and Example 7 cryopreserved at −20° C. for 1 day had the decreased crunchy texture of the wrapper 3 hours after the cooking, and the samples of Comparative Example 2 and Example 7 cryopreserved for the longer period (2 months) lost a crunchy texture even 10 minutes after the cooking. By contrast, the samples of Example 6 maintained a crunchy texture and were also favorably bitten off even after increase in time elapsed from the microwaving and in cryopreservation period at −20° C.

Results of these Evaluations 1 to 4 are shown in Tables 1-1 to 1-6. In Tables 1-1 to 1-6, the left columns in the left/right divided boxes of each Example and each Comparative Example represent evaluation results of “crunchy texture”, and the right columns represent evaluation results of “bitten-off texture”.

TABLE 1-1
◯ Evaluations 1 and 3: Freezing [symbol] Cooking with oil;
Evaluation of texture depending on time elapsed from cooking

| | | Example 1 | | Example 2 | | Example 3 | |
|---|---|---|---|---|---|---|---|
| | | Crunchy | Bitten-off | Crunchy | Bitten-off | Crunchy | Bitten-off |
| | | texture | texture | texture | texture | texture | texture |
| 2-month | 10 minutes | 5.0 | 5.0 | 5.0 | 5.0 | 4.5 | 4.3 |
| cryopreservation | after | | | | | | |
| | cooking | | | | | | |
| | 3 hours | 5.0 | 4.9 | 5.0 | 4.8 | 4.4 | 4.0 |
| | after | | | | | | |
| | cooking | | | | | | |
| | 6 hours | 4.6 | 4.8 | 4.8 | 4.5 | 4.2 | 3.5 |
| | after | | | | | | |
| | cooking | | | | | | |

| | | | |
|---|---|---|---|
| Overall | 4.9 | 4.9 | 4.2 |
| evaluation | | | |

TABLE 1-2
◯ Evaluations 1 and 3: Freezing [symbol] Cooking with oil; Evaluation
of texture depending on time elapsed from cooking

| | | | | | | Comparative | |
|---|---|---|---|---|---|---|---|
| | | Example 4 | | Example 5 | | Example 1 | |
| | | Crunchy | Bitten-off | Crunchy | Bitten-off | Crunchy | Bitten-off |
| | | texture | texture | texture | texture | texture | texture |
| 2-month | 10 minutes | 4.0 | 2.0 | 3.9 | 2.5 | 4.1 | 3.3 |
| cryopreservation | after | | | | | | |
| | cooking | | | | | | |
| | 3 hours | 3.5 | 1.3 | 3.5 | 1.6 | 2.5 | 2.3 |
| | after | | | | | | |
| | cooking | | | | | | |
| | 6 hours | 3.1 | 1.0 | 3.0 | 1.0 | 1.8 | 1.8 |
| | after | | | | | | |
| | cooking | | | | | | |

| | | | |
|---|---|---|---|
| Overall | 2.5 | 2.6 | 2.6 |
| evaluation | | | |

TABLE 1-3
◯ Evaluations 1 and 3: Freezing [symbol] Cooking with oil; Evaluation
of texture depending on time elapsed from cooking

| | | | | | | Comparative | |
|---|---|---|---|---|---|---|---|
| | | Example 6 | | Example 7 | | Example 2 | |
| | | Crunchy | Bitten-off | Crunchy | Bitten-off | Crunchy | Bitten-off |
| | | texture | texture | texture | texture | texture | texture |
| 2-month | 10 minutes | 4.8 | 4.7 | 4.0 | 1.6 | 4.0 | 3.0 |
| cryopreservation | after | | | | | | |
| | cooking | | | | | | |
| | 3 hours | 4.5 | 4.5 | 3.3 | 1.0 | 2.4 | 2.2 |
| | after | | | | | | |
| | cooking | | | | | | |
| | 6 hours | 4.3 | 4.3 | 2.9 | 1.0 | 1.6 | 1.5 |
| | after | | | | | | |
| | cooking | | | | | | |

| | | | |
|---|---|---|---|
| Overall | 4.5 | 2.3 | 2.5 |
| evaluation | | | |

TABLE 1-4
◯ Evaluations 2 and 4: Cooking with oil [symbol] Freezing [symbol]
Cryopreservation [symbol] Microwaving;
Evaluation of texture depending on cryopreservation period and time elapsed
from cooking

| | | Example 1 | | Example 2 | | Example 3 | |
|---|---|---|---|---|---|---|---|
| | | Crunchy | Bitten-off | Crunchy | Bitten-off | Crunchy | Bitten-off |
| | | texture | texture | texture | texture | texture | texture |
| 1-day | 10 minutes | 5.0 | 5.0 | 4.9 | 4.9 | 4.5 | 4.3 |
| cryopreservation | after | | | | | | |
| | cooking | | | | | | |
| | 3 hours | 4.6 | 4.6 | 4.7 | 4.3 | 4.2 | 3.8 |
| | after | | | | | | |
| | cooking | | | | | | |
| | 6 hours | 4.1 | 4.6 | 4.4 | 4.1 | 4.0 | 3.5 |
| | after | | | | | | |
| | cooking | | | | | | |

| | | | |
|---|---|---|---|
| Overall | 4.7 | 4.6 | 4.1 |
| evaluation | | | |

| | | | | | | | |
|---|---|---|---|---|---|---|---|
| 2-month | 10 minutes | 4.8 | 4.8 | 4.8 | 4.8 | 4.3 | 3.7 |
| cryopreservation | after | | | | | | |
| | cooking | | | | | | |
| | 3 hours | 4.2 | 4.5 | 4.4 | 4.3 | 4.0 | 3.4 |
| | after | | | | | | |
| | cooking | | | | | | |
| | 6 hours | 4.0 | 4.3 | 4.2 | 4.0 | 3.8 | 3.1 |
| | after | | | | | | |
| | cooking | | | | | | |

| | | | |
|---|---|---|---|
| Overall | 4.4 | 4.4 | 3.7 |
| evaluation | | | |

TABLE 1-5
◯ Evaluations 2 and 4: Cooking with oil [symbol] Freezing [symbol]
Cryopreservation [symbol] Microwaving;
Evaluation of texture depending on cryopreservation period and time elapsed
from cooking

| | | | | | | Comparative | |
|---|---|---|---|---|---|---|---|
| | | Example 4 | | Example 5 | | Example 1 | |
| | | Crunchy | Bitten-off | Crunchy | Bitten-off | Crunchy | Bitten-off |
| | | texture | texture | texture | texture | texture | texture |
| 1-day | 10 minutes | 4.0 | 1.8 | 3.9 | 2.3 | 4.3 | 3.1 |
| cryopreservation | after | | | | | | |
| | cooking | | | | | | |
| | 3 hours | 3.4 | 1.2 | 3.3 | 1.2 | 3.0 | 2.3 |
| | after | | | | | | |
| | cooking | | | | | | |
| | 6 hours | 3.0 | 1.0 | 3.0 | 1.0 | 2.7 | 2.0 |
| | after | | | | | | |
| | cooking | | | | | | |
| | Overall | 2.4 | | 2.5 | | 2.9 | |
| | evaluation | | | | | | |
| 2-month | 10 minutes | 3.5 | 1.0 | 3.6 | 1.0 | 3.2 | 2.5 |
| cryopreservation | after | | | | | | |
| | cooking | | | | | | |
| | 3 hours | 3.0 | 1.0 | 2.9 | 1.0 | 2.0 | 1.6 |
| | after | | | | | | |
| | cooking | | | | | | |
| | 6 hours | 2.5 | 1.0 | 2.4 | 1.0 | 1.2 | 1.0 |
| | after | | | | | | |
| | cooking | | | | | | |

| | | | |
|---|---|---|---|
| Overall | 2.0 | 2.0 | 1.9 |
| evaluation | | | |

TABLE 1-6
◯ Evaluations 2 and 4: Cooking with oil [symbol] Freezing [symbol]
Cryopreservation [symbol] Microwaving;
Evaluation of texture depending on cryopreservation period and time elapsed
from cooking

| | | | | | | Comparative | |
|---|---|---|---|---|---|---|---|
| | | Example 6 | | Example 7 | | Example 2 | |
| | | Crunchy | Bitten-off | Crunchy | Bitten-off | Crunchy | Bitten-off |
| | | texture | texture | texture | texture | texture | texture |
| 1-day | 10 minutes | 4.7 | 4.5 | 3.9 | 1.4 | 3.8 | 2.6 |
| cryopreservation | after | | | | | | |
| | cooking | | | | | | |
| | 3 hours | 4.3 | 4.0 | 3.2 | 1.0 | 2.1 | 2.0 |
| | after | | | | | | |
| | cooking | | | | | | |
| | 6 hours | 4.2 | 3.8 | 2.8 | 1.0 | 1.3 | 1.3 |
| | after | | | | | | |
| | cooking | | | | | | |
| | Overall | 4.3 | | 2.2 | | 2.2 | |
| | evaluation | | | | | | |
| 2-month | 10 minutes | 4.6 | 4.3 | 3.4 | 1.0 | 3.0 | 2.0 |
| cryopreservation | after | | | | | | |
| | cooking | | | | | | |
| | 3 hours | 4.2 | 3.8 | 2.8 | 1.0 | 1.9 | 1.0 |
| | after | | | | | | |
| | cooking | | | | | | |
| | 6 hours | 3.9 | 3.5 | 2.2 | 1.0 | 1.0 | 1.0 |
| | after | | | | | | |
| | cooking | | | | | | |

| | | | |
|---|---|---|---|
| Overall | 4.1 | 1.9 | 1.7 |
| evaluation | | | |

The present invention can provide: a wrapped food to be fried that allows a wrapped fried food to effectively maintain its oil cooking-derived crunchy texture based on the layered structure of wrappers wrapped around an ingredient; a wrapped fried food obtained by cooking the same with oil; and methods for producing these foods.

1. A wrapped food to be fried comprising an ingredient and a wrapper portion wrapped around the ingredient, wherein the wrapper portion at least partially has a layered structure consisting of 10 or more wrapper layers in a rolled-up state.

2. The wrapped food to be fried according to claim 1, wherein the wrapper layers each have a thickness ranging from 0.1 mm to 0.6 mm.

3. The wrapped food to be fried according to claim 1, wherein the wrapped food to be fried is obtained by shaping wrapper dough by baking or rolling into each sheet having a thickness from 0.1 mm to 0.6 mm, stacking the sheets up to a thickness within 1 mm, and then wrapping the ingredient.

4. The wrapped food to be fried according to claim 1, wherein the wrapped food to be fried is obtained by shaping wrapper dough by baking or rolling into a sheet having a thickness from 0.1 mm to 0.6 mm, placing the ingredient on the baked or rolled wrapper, then covering the ingredient with an additional wrapper such that the stacked wrapper portion is within 1 mm in thickness, and wrapping the ingredient.

5. A wrapped fried food obtained by cooking, with oil, a wrapped food to be fried according to claim 1.

6. A method for producing a wrapped food to be fried comprising an ingredient wrapped in a wrapper portion, comprising
wrapping the ingredient in the wrapper portion to thereby form at least a portion of the wrapper portion wrapped around the ingredient, as a layered structure consisting of or more wrapper layers in a rolled-up state.

7. The method according to claim 6, wherein the wrapper layers each have a thickness ranging from 0.1 mm to 0.6 mm.

8. The method according to claim 6, comprising shaping wrapper dough by baking or rolling into each sheet having a thickness from 0.1 mm to 0.6 mm, stacking the sheets up to a thickness within 1 mm, and then wrapping the ingredient.

9. The method according to claim 7, comprising shaping wrapper dough by baking or rolling into each sheet having a thickness from 0.1 mm to 0.6 mm, stacking the sheets up to a thickness within 1 mm, and then wrapping the ingredient.

10. The method according to claim 6, comprising shaping wrapper dough by baking or rolling into a sheet having a thickness from 0.1 mm to 0.6 mm, placing the ingredient thereon, then covering the ingredient with an additional wrapper such that the stacked wrapper portion is within 1 mm in thickness, and wrapping the ingredient.

11. The method according to claim 7, comprising shaping wrapper dough by baking or rolling into a sheet having a thickness from 0.1 mm to 0.6 mm, placing the ingredient thereon, then covering the ingredient with an additional wrapper such that the stacked wrapper portion is within 1 mm in thickness, and wrapping the ingredient.

12. A method for producing a wrapped fried food, comprising the step of cooking, with oil, a wrapped food to be fried according to claim 1.

13. A wrapped fried food obtained by the step of cooking, with oil, a wrapped food to be fried obtained by a method according to claim 6.
